(19) United States
(12) Patent Application Publication
(10) Pub. No.: US 2024/0160303 A1
(43) Pub. Date: May 16, 2024

(54) CONTROL METHOD OF A TOUCHPAD

(71) Applicant: ELAN MICROELECTRONICS CORPORATION, Hsinchu (TW)

(72) Inventors: Chang-Ru CHEN, Changhua City (TW); Tuan-Ying CHANG, Tainan City (TW); Hsueh-Wei YANG, Zhubei City (TW)

(73) Assignee: ELAN MICROELECTRONICS CORPORATION, Hsinchu (TW)

(21) Appl. No.: 18/499,004

(22) Filed: Oct. 31, 2023

(30) Foreign Application Priority Data
Nov. 10, 2022 (TW) 111143066

(51) Int. Cl. G06F 3/0354; G06N 3/02

(52) U.S. Cl. CPC G06F 3/03547; G06N 3/02

(57) ABSTRACT

A control method of a touchpad is provided. The touchpad has a determination module including a neural network. The determination module is used to determine the type of object. When the user uses the touchpad, the touchpad uses the captured object feature data of the touch object to update the determination module. Therefore, when determining the type of the touch object, the updated determination module can more accurately determine the touch object used by the user, so as to improve the determination accuracy.

### CROSS-REFERENCE TO RELATED APPLICATIONS

This application is based upon and claims priority under 35 U.S.C. 119 from Taiwan Patent Application No. 111143066 filed on Nov. 10, 2022, which is hereby specifically incorporated herein by this reference thereto.

### BACKGROUND OF THE INVENTION

### 1. Field of the Invention

This invention relates to a touchpad, specifically to a method for controlling a touchpad.

### 2. Description of the Prior Arts

Touchpads are widely used as input interfaces in mobile electronic devices. The touchpads function by detecting information such as the location of contact, contact duration, and movement speed of a user's finger or other touch objects on the touchpad. This information is used to determine the touch events that the user intends to trigger and subsequently execute the corresponding commands. During use, both the user's fingers and palm may come into contact with the touchpad. In typical usage, users primarily use their fingers to initiate touch events. However, in many cases, touch events triggered by the palm are accidental. Therefore, it is essential for the touchpads to distinguish contacts between finger and palm to prevent unintended touch events.

In the prior art, the touchpads typically rely on preset parameters to determine whether the touching object is a finger or a palm. These parameters may include factors such as the touch area and the slope of the touch sensing value. However, manually set default conditions are fixed, and when encountering different users or different usage scenarios, the default conditions may not be flexible enough to adapt, leading to potential misjudgments.

### SUMMARY OF THE INVENTION

To overcome the shortcomings, the present invention provides a control method of a touchpad to mitigate or to obviate the aforementioned problems.

The present invention provides a control method of a touchpad comprising steps of: a. providing a determination module, wherein the determination module comprises object feature data of touch objects in a first group, and includes a neural network; b. acquiring touch sensing information of a touch object in a second group to obtain corresponding object feature data of the touch object in the second group from the touch sensing information of the same, wherein the touch objects in the first group and the touch object in the second group are obtained from different users; and c. providing the object feature data of the touch object in the second group to the neural network to update the determination module, wherein the object feature data of the touch object in the second group and the object feature data of the touch objects in the first group have corresponding format.

Other objectives, advantages and novel features of the invention will become more apparent from the following detailed description when taken in conjunction with the accompanying drawings.

### BRIEF DESCRIPTION OF THE DRAWINGS

FIG. 1 is illustrating the architecture of the neural network;

FIG. 2 is representing a schematic of touch sensing values;

FIG. 3 is displaying a schematic for analyzing touch area and touch sensing value information of captured touch objects.

FIG. 4 illustrates the analysis of the length information of captured touch objects;

FIG. 5 demonstrates the analysis of the center of gravity position information of the first object;

FIG. 6 is a flowchart of a first embodiment of a control method in accordance with the present invention;

FIG. 7 is a flowchart of a second embodiment of a control method in accordance with the present invention; and

FIG. 8 is a clustering schematic for the clustering step of the control method in FIG. 7.

### DETAILED DESCRIPTION OF THE EMBODIMENTS

The following, in conjunction with the drawings and embodiments of the present invention, further elaborates on the technical means adopted by the present invention to achieve its intended objectives.

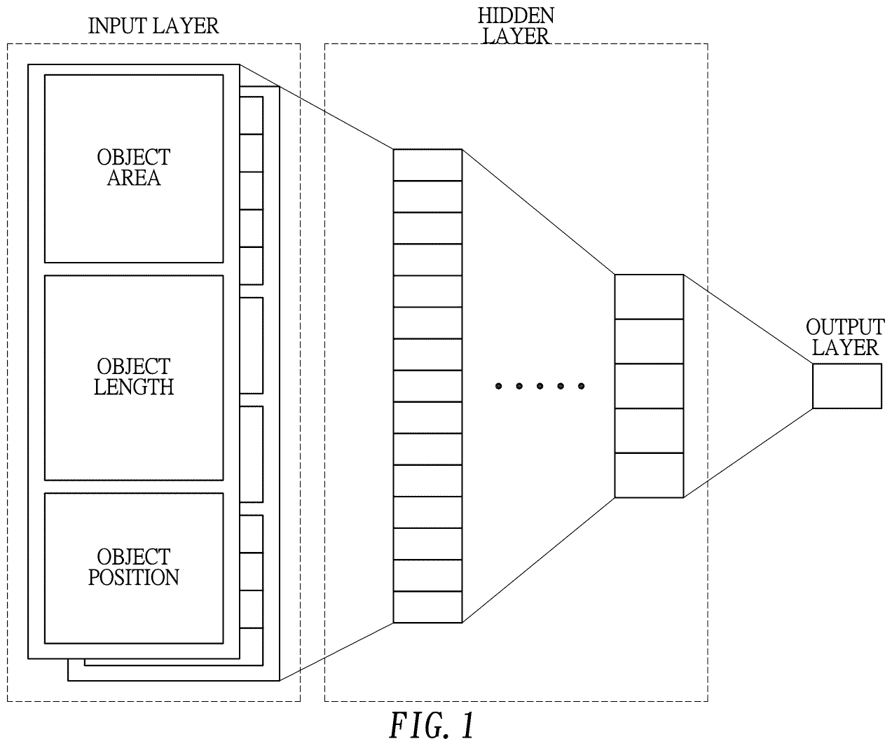

A touchpad in accordance with the present invention comprises a determination module that includes a neural network. The basic structure of the neural network is illustrated in FIG. 1 and includes an input layer, multiple hidden layers and an output layer. In the input layer, multiple features are extracted from the touch sensing information of at least one touch object, resulting in multiple object feature data. In the hidden layers, further computational processing is performed on the information processed in the input layer or another hidden layer. The output layer receives the final result from the hidden layers and outputs it as a determination result. For example, in the present invention, when a touch object is detected, the input layer of the neural network receives the touch sensing information of the touch object. After processing in the hidden layers, the output layer provides the determination result, such as identifying the touch object as a finger, palm, or stylus. The neural network may be a deep neural network (DNN), convolutional neural network (CNN), recurrent neural network (RNN), or any other type, with specific details not provided here. Furthermore, when the touch sensing information is generated for each frame, computational processing takes place in the input layer, involving the object feature data from the current frame and the preceding frame.

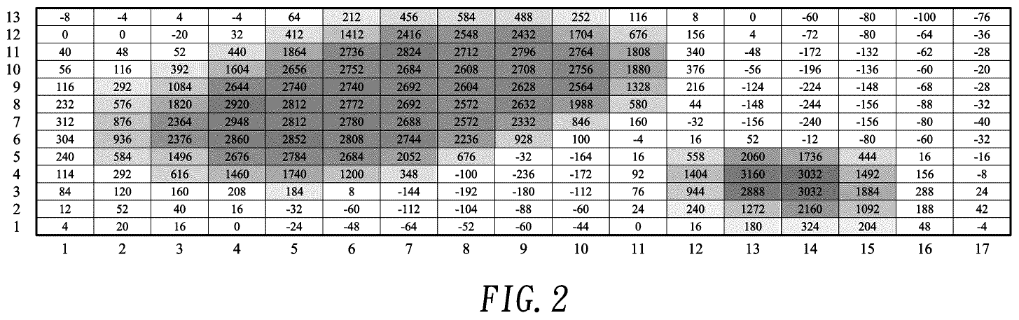

In one embodiment, the determination module comprises multiple object feature data related to touch objects in a first group, which includes various types of touch objects such as fingers and palms. The fingers within the first group may further encompass different types of fingers, like thumbs and index fingers, for instance. Moreover, the various types of the touch objects in the first group include multiple object feature data of multiple different types of touch objects, such as multiple object feature data of multiple fingers and multiple palms respectively. The object feature data includes a variety of feature data used to distinguish fingers and palms. In one embodiment, the determination module is trained by the neural network based on the object feature data of the touch objects in the first group. After training, the determination module generates relevant parameter results for determining the type of object. The following is merely an illustration, and FIG. 2 serves as an example of a touch sensing value diagram, but it is not limited thereto. FIG. 2 illustrates touch sensing values generated when different touch objects contact with the touchpad.

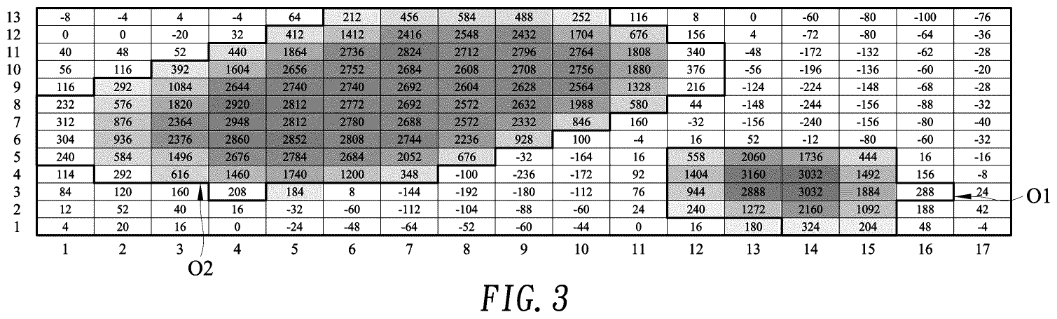

In one embodiment, the object feature data includes an analysis of the size of the touch sensing values of the touch objects. By analyzing the touch sensing values of the touch objects, information about the touch sensing area is obtained, and further determinations are made based on these proportions. For example, with reference to FIG. 3, the selection of effective touch sensing values within a frame allows the determination of the area occupied by the touch objects. By using the touch sensing values greater than 200 as effective touch sensing values, the touch areas of a first object O1 and a second object O2 may be determined accordingly.

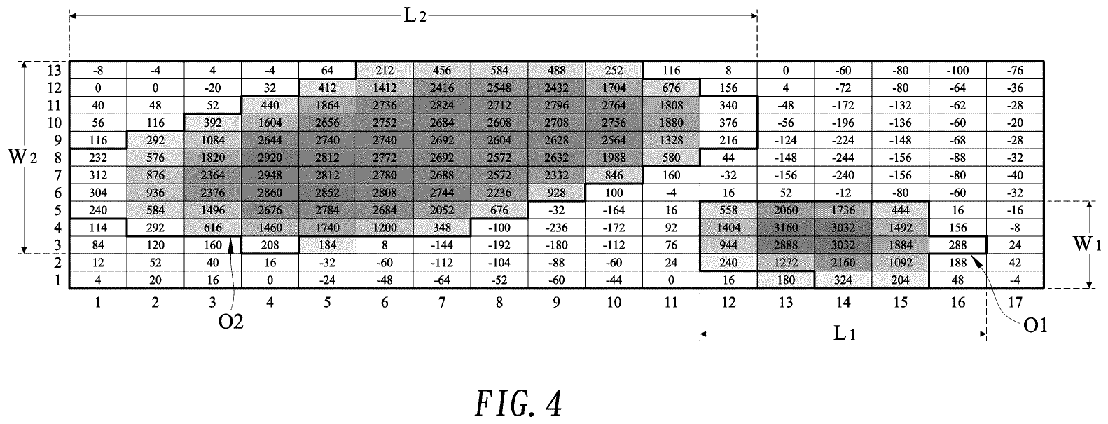

In one embodiment, the object feature data includes length analysis information of the touch objects. By obtaining information about the horizontal and vertical lengths of the touch objects, the behavior of the touch objects is determined. For example, with reference to FIG. 4, the horizontal and vertical lengths of both the first object O1 and the second object O2 are analyzed. For instance, the horizontal length L1 of the first object O1 extends from X-axis 12 to 16, and the vertical length W1 of the first object O1 extends from Y-axis 1 to 5. The horizontal length L2 of the second object O2 extends from X-axis 1 to 12, and the vertical length W2 of the second object O2 extends from Y-axis 3 to 13.

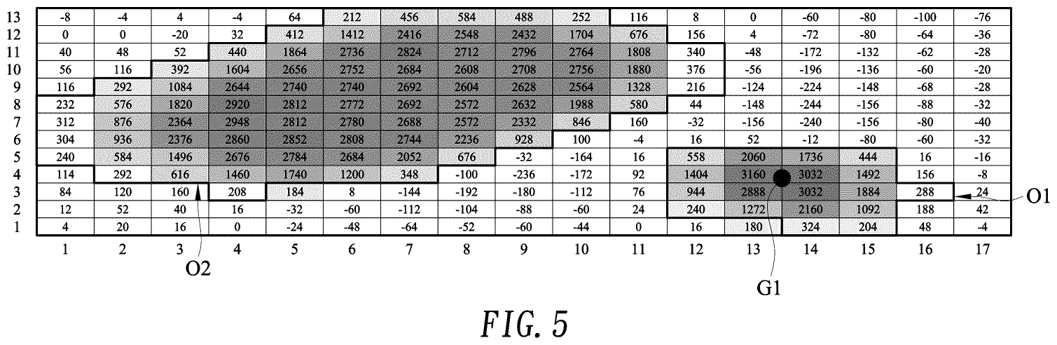

In one embodiment, the object feature data includes the center of gravity position of the touch objects based on the touch sensing values thereof. For example, with reference to FIG. 5, where the center of gravity G1 of the first object O1 is calculated. After calculation, it is determined that the center of gravity G1 is located between coordinates (13, 4) and (14, 4). In one embodiment, the calculation of the center of gravity G1 is based on the average of the product of the touch sensing values and the coordinates for each coordinate of the first object O1.

The various types of the object feature data mentioned above include information such as the analysis of touch sensing values' magnitudes, the analysis of the horizontal and vertical projection values of touch sensing values, and the analysis of the center of gravity of touch sensing values along with its distances relative to each side, etc. Through the neural network, these object feature data are used for training and generating the determination module. By continually training and updating the determination module using the aforementioned object feature data, the determining accuracy of the type of the object is enhanced.

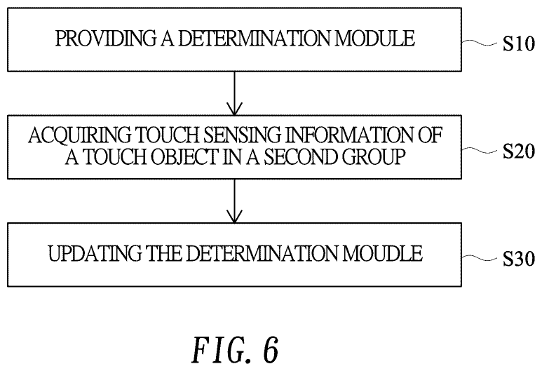

With reference to FIG. 6, a first embodiment of a control method in accordance with the present invention comprises the following steps:

Providing a determination module (S10): The determination module comprises object feature data of touch objects in the first group, and includes a neural network.

Acquiring touch sensing information of a touch object in the second group (S20): The touch sensing information of the touch object in the second group is acquired when the touch object in the second group contacts with the touchpad. The touch object in the second group may consist of a single object or multiple objects, such as fingers and/or palms. The touch object in the second group may also include multiple objects of different types, for example, a composition of multiple fingers or multiple palms. The touch sensing information corresponds to acquire the object feature data of the touch object in the second group. The format of the object feature data of the touch object in the second group corresponds to the format of the object feature data of the touch object in the first group. For instance, the object feature data of the touch objects in the first group contained in the determination module includes information such as the analysis of the size of touch sensing values, the analysis of horizontal and vertical projection values of touch sensing values, the distance of the center of gravity of the touch object with respect to the edges of the touchpad, and other related information. The object feature data of the touch object in the second group also includes the same type of information in a corresponding format. For example, if the object feature data of the touch objects in the first group includes data regarding the analysis information of the touch object's touch area, the horizontal and vertical length analysis and the center of gravity position for the touch sensing values, the object feature data of the touch object in the second group have data in the same format for their respective features.

Updating the determination module (S30): The object feature data of the touch object in the second group is provided to the neural network to update the relevant parameter results of the determination module used for determining the type of object. This means that by using the current object feature data obtained from the touch object in the second group, the neural network is trained to enhance the accuracy for determining the type of the touch object of the user.

Furthermore, the touch objects in the first group and the touch objects in the second group are provided by different users. Specifically, the touch objects in the first group is collected from a large number of users' fingers and palms before the touchpad leaves the factory, while the touch object in the second group is collected from the specific user's fingers and palms after being sold to that specific user. Since the determination module has completed the initial training in the step S10, the step S30 only requires providing the object feature data of the touch object in the second group to the neural network. This efficient approach reduces the storage space requirements and lowers hardware burdens.

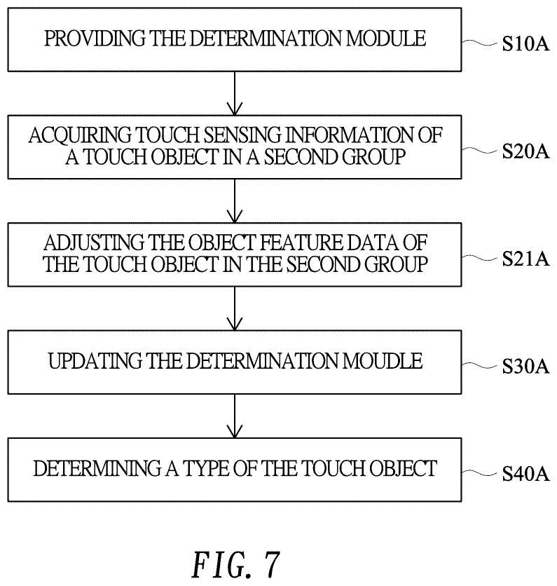

With reference to FIG. 7, a second embodiment of a control method in accordance with the present invention comprises the same steps as the first embodiment, including steps of providing a determination module (S10A), acquiring touch sensing information of a touch object in the second group (S20A), and updating the determination module (S30A). The second embodiment of the control method as described further comprises steps of adjusting the object feature data of the touch object in the second group (S21A), and determining a type of the touch object (S40A). The step S21A is executed between the steps S20A and S30A, and the step S40A is executed after the step S30A.

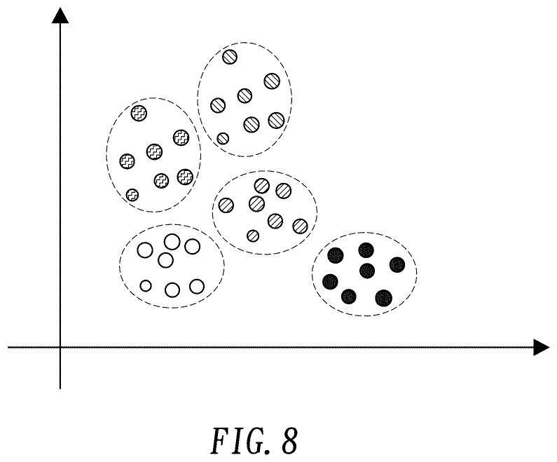

The aforementioned step of adjustment of object feature data (S21A) is used to process the object feature data of the touch object in the second group that has been captured for updating the determination module (S30A). In one embodiment, the step S21A includes a gain step, which processes the object feature data of the touch object in the second group to increase the amount of the object feature data. In one embodiment, the gain step is a mirroring step that mirrors the object feature data of the touch object in the second group, effectively doubling the amount of the object feature data. In one embodiment, the step S21A includes a clustering step and a balancing step. For example, when dealing with the object feature data corresponding to a finger of the touch object in the second group, the K-means algorithm is used to cluster the object feature data as shown in FIG. 8. This process may involve clustering the data into five sets based on the adjacent data points on the coordinate axes. The details of the K-means algorithm are not discussed here. In one embodiment, the step S21A may be executed sequentially with the mirroring step, the clustering step and the balancing step, followed by a normalization step before proceeding to the step S30A. The normalization step involves normalizing the adjusted object feature data of the touch object in the second group.

The step of determining the type of touch object (S40A) is performed by using the updated determination module to determine the type of another touch object. For example, when a user continues to use the touchpad and touches it with another touch object, the type of the touch object is determined by using the updated determination module. The determination may include identifying whether it is a finger or a palm, for instance.

In one embodiment, before executing the step S20A, a correction training program is triggered. Under the correction training program's interface, the users input the touch sensing information of the touch objects in the second group. Afterward, the touchpad proceeds to execute the step S20A. Furthermore, within the interface of the correction training program, various instructions are generated. The users can follow these instructions to sequentially place different fingers and palms in different positions on the touchpad to perform various touch behaviors or gestures. Thus, the acquired touch sensing information of the touch objects in the second group covers more aspects to allow for more comprehensive data to update the determination module.

In another embodiment, the steps S20 and S20A are executed in the background of the operating system, meaning that the steps S20 and S20A are performed without the need to pre-trigger a specific training program. For example, when a user is typing on a physical keyboard, the objects touching the touchpad are likely to be palms. During this time, the touch sensing information from these palms is captured, and multiple object feature data are obtained. This data is then used to update the determination module (S30).

In summary, the control method as described utilizes the touch sensing information obtained from the touch objects in the second group on the touchpad to update the determination module. This allows the determination module to be enhanced not only through training with the default touch objects in the first group but also through reinforcement training with the actual use of the touch objects in the second group on the touchpad. Consequently, in the future use of the touchpad by different users, the neural network, after reinforcement training, more accurately distinguishes between various fingers and palms, thereby improving the precision of subsequent gesture and touch event recognition.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A control method of a touchpad comprising steps of:
a. providing a determination module, wherein the determination module comprises object feature data of touch objects in a first group, and includes a neural network;
b. acquiring touch sensing information of a touch object in a second group to obtain corresponding object feature data of the touch object in the second group, wherein the touch objects in the first group and the touch object in the second group belong to different users; and
c. providing the object feature data of the touch object in the second group to the neural network to update the determination module, wherein the object feature data of the touch object in the second group and the object feature data of the touch objects in the first group have corresponding formats.

2. The control method as claimed in claim 1, wherein in the step b, the touch sensing information of the touch object in the second group includes multiple touch sensing values of the touch object in the second group, and the object feature data of the touch object in the second group includes an touch area of the touch object.

3. The control method as claimed in claim 1, wherein in the step b, the touch sensing information of the touch object in the second group includes multiple touch sensing values of the touch object in the second group, and the object feature data of the touch object in the second group includes a vertical length and a horizontal length of the touch object in the second group.

4. The control method as claimed in claim 1, wherein in the step b, the touch sensing information of the touch object in the second group includes a center of gravity of multiple touch sensing values of the touch object in the second group, and the object feature data of the touch object in the second group includes the position information of the center of gravity.

5. The control method as claimed in claim 1 further comprising steps of:
b1. adjusting the object feature data of the touch object in the second group, which is executed between the steps b and c.

6. The control method as claimed in claim 5, wherein the step b1 performs a step of gaining the object feature data of the touch object in the second group.

7. The control method as claimed in claim 6, wherein the step of gaining the object feature data of the touch object in the second group is to mirror the object feature data of the touch object in the second group.

8. The control method as claimed in claim 5, wherein the step b1 performs a step of clustering the object feature data of the touch object in the second group.

9. The control method as claimed in claim 5 further comprising a step of normalizing the adjusted object feature data of the touch object in the second group after the step b1.

10. The control method as claimed in claim 1, wherein before the step b is executed, a correction training program is triggered to execute the step b, and the correction training program includes an interface to generate multiple instructions.

11. The control method as claimed in claim 1, wherein the steps b and c are executed in a background of an operating system.

12. The control method as claimed in claim 1 further comprising a step of determining a type of a touch object by using the updated determination module, which is executed after the step c.

13. The control method as claimed in claim 1, wherein in the step a, the determination is trained by the neural network based on the object feature data of the touch objects in the first group.
